(19) United States
(12) Patent Application Publication
(10) Pub. No.: US 2019/0246807 A1
(43) Pub. Date: Aug. 15, 2019

(54) ANTI-SLIP ATHLETIC EQUIPMENT COVER

(71) Applicants: Timothy A. Hensley, Clinton Twp., MI (US); Andrew C. Axtell, Royal Oak, MI (US)

(72) Inventors: Timothy A. Hensley, Clinton Twp., MI (US); Andrew C. Axtell, Royal Oak, MI (US)

(21) Appl. No.: 16/276,145

(22) Filed: Feb. 14, 2019

Related U.S. Application Data
(60) Provisional application No. 62/630,421, filed on Feb. 14, 2018.

(51) Int. Cl. A47C 31/11; B32B 25/04; A63B 21/00

(52) U.S. Cl. CPC A47C 31/11; B32B 25/04; A63B 21/4029; A63B 2209/00; B32B 2307/744; B32B 2571/00; B32B 2274/00; A63B 21/4039

(57) ABSTRACT

A cover for an exercise athletic appliance comprising a multi-layer cover having a upper surface, a lower surface and a liner secured to the lower surface, the liner contacting the appliance and the liner being an anti-slip material having a length and width sufficient to cover at least the top surface of the appliance.

### CROSS-REFERENCE TO RELATED APPLICATION

This application is a completion application of co-pending U.S. Provisional Patent Application No. 62/630,421, filed Feb. 14, 2018 for “Anti-Slip Athletic Equipment Cover”, the entire disclosure of which is hereby incorporated by reference, including the drawing.

### BACKGROUND OF THE INVENTION

### 1. Field of the Invention

The present invention pertains to removable covers. More particularly, the present invention pertains to covers for athletic equipment. Even more particularly the present invention pertains to anti-slip removable covers for athletic equipment.

### 2. Prior Art

As is known to those skilled in the art to which the present invention pertains, fitness gyms provide various types of benches for performing various types of exercises, including weight lifting, limb stretching and so forth.

Typically, especially with weight lifting, the user reclines or lies at least partially supine on a bench. Ordinarily, these benches are wide slats or boards having a cushioned cover disposed thereover. In use, as the covers absorb perspiration, etc., from the users, the users have a tendency to slip along the extent of the bench itself. Yet, it is important that the users stay stationary in position so there is consistency not only with the exercise or weight lifting, itself, but to prevent potential injury.

Furthermore, these benches ordinarily are continuously being reused in gyms. Yet, little or no attention is made to maintaining the cover in a sanitary condition.

Thus, it would be beneficial to provide a personal or removable cover for use on such benches in gyms, or even at home, that can be cleaned and maintained in a sanitary condition while facilitating the deployment thereof as well as being “anti-slip”.

It is appreciated that the art has addressed some of the issues described herein. For example, in U.S. Patent Application Publication No. US/2016/0151697, there is disclosed a slip cover that is shaped and sized to be removably attached onto an exercise machine. However, the cover fails to address the inherent slippage when in use while being sized solely to facilitate use on only one type of bench.

Further, in U.S. Patent Application Publication No. 2008/00068 there is disclosed a fitness equipment cover that has an elongated centerpiece of material which ends at a hood at one end to enable the cover to be slipped over the free end of the equipment.

Also, in U.S. Patent Publication No. 2004/0147381, there is disclosed a cover for back supports, seats and other surfaces of sports appliances which is removably fitted onto the support surface. The cover, also, enables the attachment of several types of adjustable elements depending on the portion of the torso to be treated. However, again, the cover does not address the issue of slippage.

Thus, it is to be appreciated that there remains a need for an improved sports equipment cover which addresses both sanitary conditions as well as slippage. It is to this to which the present invention is directed.

### SUMMARY OF THE INVENTION

In accordance with the present invention there is provided a cover for an athletic appliance, such as a bench or other athletic and/or exercise equipment, characterized by a sheet of “tacky” or anti-slip material having a length and width sufficient to cover at least the top surface of a fitness equipment bench.

More particularly, the cover comprises a layered sheet of material having a front or body engaging surface and a back or rear or bench engaging surface. The sheet has a first formed end and an opposite formed second end.

A liner, formed from a tacky or anti-slip material, is secured to the back surface and has a dimension substantially equal to the length of the cover. In use, the liner is in contact with the bench. The liner, itself, provides additional support to the back of the user.

A puckered portion of the cover is provided at both ends of the cover.

Means, such as an elastic band, may be secured within the puckered portion to enable at least one end of the cover to be elongated width wise, or stretched to accommodate various sizes of benches. Certainly, the entire cover may be so-puckered so as to be stretched length wise and width wise.

Means, such as a combination of a clip and receptor, enable the cover to be detachably secured to the bench.

For a more complete understanding of the present invention reference is made to the following detailed description and the accompanying drawing. In the drawing like reference characters refer to like parts throughout the several views in which:

### BRIEF DESCRIPTION OF THE DRAWINGS

FIG. 1 is a plan view of a first embodiment the cover hereof in use with a weight lifting bench;

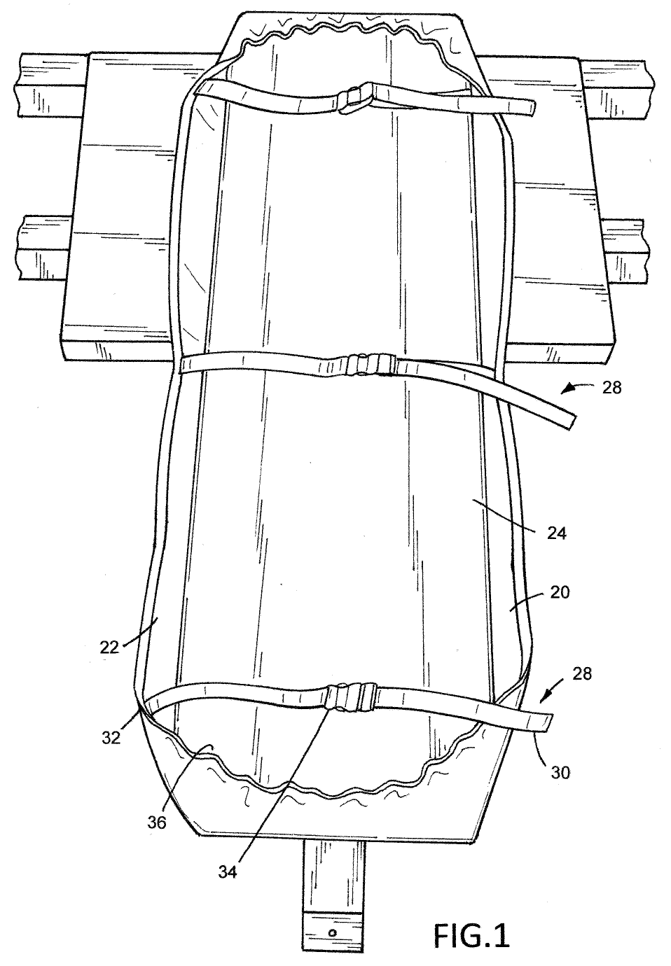

FIG. 2 is a plan view of the rear surface of the cover hereof;

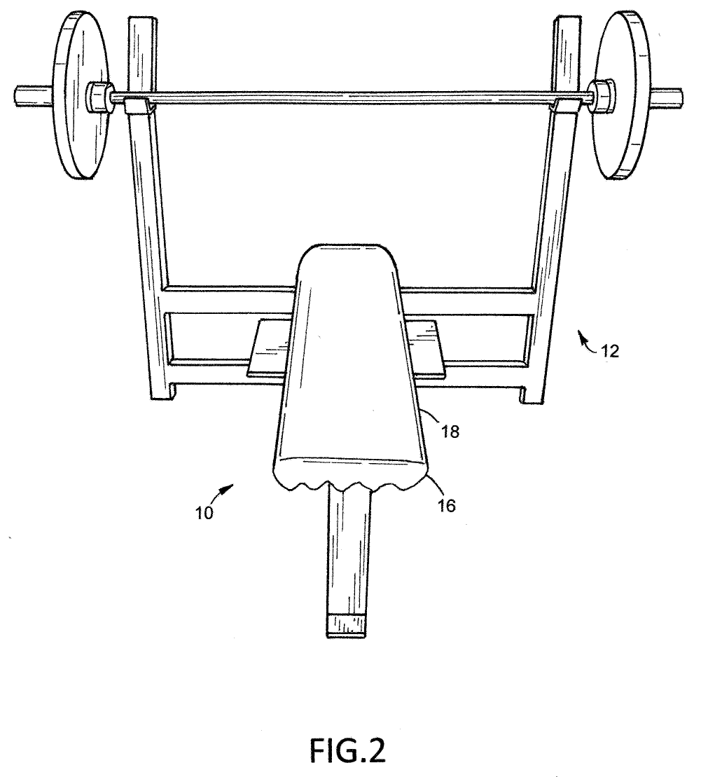

FIG. 3 is a plan view of an alternative embodiment of the cover hereof; and

FIG. 4 is a cross-sectional view of the embodiment taken along line 4-4 of FIG. 3.

### DETAILED DESCRIPTION OF THE INVENTION

Now, in accordance with the present invention and with reference to the drawing there is shown therein, a cover, generally, denoted at 10. Herein, the cover is shown as being deployed in connection with weight lifting equipment 12.

It is to be understood, however, that although the present invention is described with reference to weight lifting equipment, the cover hereof is equally applicable to other types of exercise and/or fitness equipment.

Referring, again to the drawing, as shown, the equipment 12 includes a weight stand 13 and a bench 15 on which a user lies when in use. The bench has a forward end 17 and a rearward end 19.

As is known to those skilled in the art to which the present invention pertains, and as discussed above, the weight lifter either lies flat or is partially supine on the bench in utilizing the equipment.

The cover 10 overlies the bench 15, which has a forward end 14 and a rearward end 16. The cover 10 encases the bench and enshrouds the entirety thereof including the terminal ends, i.e., the forward end 17 and the rearward end 19 of the bench.

The cover has a top surface 18 and a lower surface 20.

Both the upper surface 18 and the lower surface comprise a tacky or anti-slip material of the type which is well known and commercially available. Generally, such material is formed from synthetic materials such as polyester, latex, synthetic rubber and the like. Exemplifying each sheet material is that sold commercially by Mancino Manufacturing Co., Inc.

Further, a soft liner 22 is disposed on the lower surface.

The liner 22 is adhered to the lower surface 20 of the cover by any suitable means such as sonic welding, adhesive or the like.

Disposed atop and adhered to the liner 22 is an anti-slip sheet 24 which extends along the length of the cover.

The sheet 24 is, preferably, formed from the same anti-slip or tacky material as the upper surface of the cover.

The present cover further includes means, generally, denoted at 28 for securing or detachably fastening the cover to the bench 15.

The securing or fastening means can comprise any suitable assembly for interconnecting the sides of the cover together beneath the bench. As shown herein there is utilized a pair of threadable beltings 30, 32 having a central clasp 34 of the type which is well-known and commercially available. As is known, one part of the strap is looped through the clasp and pulled back upon itself to tighten the cover against the bench and the other part of the strap is fixed to the clasp.

Other suitable means may be used, such as for example, the strap and buckle combination of the type having extensions or prongs which are received in a receptor and releasable therefrom.

It is to be understood that the means for securing or securement can comprise any suitable means which can effectuate removable securement of the cover to the appliance, be it to a bench or otherwise.

As shown in the drawing three spaced-apart separate means for securement are utilized. However, any suitable number may be used.

The cover hereof can be varied in width, if desired, to accommodate different types of boards and other equipment widths thereof. This is achieved during the manufacturing process by folding over and then sewing each end of the cover unto itself hereof to create a pucker 36, 38 at each end of the cover.

An elastic, such as at 40 may, optionally, be disposed within the pucker area to facilitate the expansion of each end.

In use, the cover is emplaced over an appliance with the ends thereof enshrouding the ends of the end of the appliance.

Thereafter, the sides of the cover are secured together by the means for securement along the extent thereof. When installed the anti-slip sheet lies atop the appliance and the user then can lie down on the cover and proceed to carry out whatever physical exercise or fitness exercise is desired.

After use the cover may be removed from the bench or other appliance.

Because of the nature of the material it can then be sprayed with a suitable cleaner and be ready for re-use.

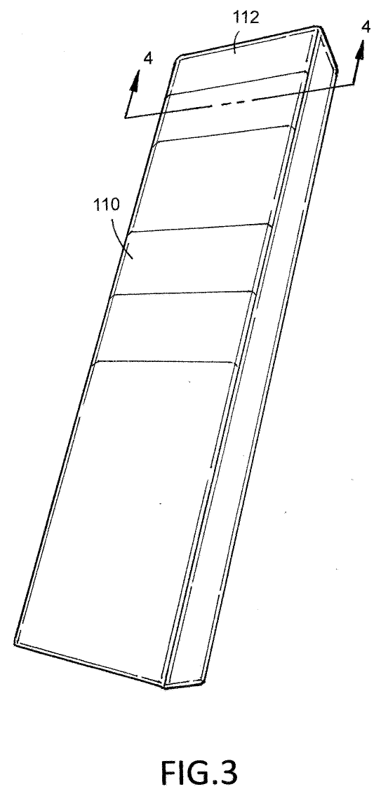

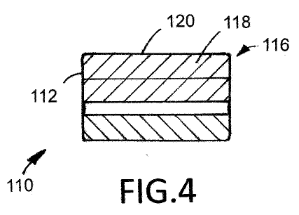

Referring now to FIGS. 3 and 4 there is depicted therein an alternate embodiment hereof.

As shown, the forward end 116 of the cover 110 is substantially similar to the first embodiment hereof except that the cover 110 has a substantially rectangular portion 112 proximate the forward end of the bench.

As shown in FIG. 4 the forward end 116 of the cover 110 comprises a layered structure which is used to square off the head and shoulder, engaging forward end 116.

The layered forward end 116 comprises the original cover 110 and an upper layer of a polyethylene 118 and, preferably, a chlorosulfonated polyethylene synthetic rubber. These polyethylene synthetic rubbers are well known and commercially available and have multiple uses because of their resistance to chemicals, temperature extremes and ultraviolet light. A further cover 120 overlies the layer 118.

Representative of such polyethylene synthetic rubbers are those sold commercially under the trademark Hypalon.

The Hypalon layer is dimensioned to enable the upper end or forward end of the cover to be “squared off”, as shown. In all other respects the cover is the same as with the first embodiment.

The upper layer is secured to the lower cover layer by any suitable means such as adhesive, sonic welding or the like.

It is to be appreciated that the present cover provides extra sticking power when a user is benching whether enshrouding the bench or not. covering the working surface of the appliance.

It is apparent from the preceding that there has been described herein a cover for fitness equipment which is anti-slip and which can be easily moved and deployed while maintaining a clean state.

Having, thus, described the invention, what is claimed is:

1. A cover for an exercise athletic appliance comprising: a multi-layered cover having an upper surface, a lower surface and a liner secured to the lower surface, and wherein the liner contacts the appliance when in use, the liner being an anti-slip material having a length and width sufficient to cover at least the top surface of the appliance.

2. The cover of claim 1 having a puckered forward first end, a puckered second opposite end, and means to enable at least the upper portion to be elongated to accommodate various sizes of appliances.

3. The cover of claim 1 which further comprises: (a) a shoulder supporting portion, the shoulder supporting portion comprising the upper surface of the cover and (b) a synthetic rubber material overlying the upper surface of the cover and being secured thereto; the cover and synthetic rubber material cooperating to provide the area sufficient to support the shoulders of the user of the appliance.

4. The cover of claim 3 which further includes means for removably detachably securing the cover to the appliance.

5. The cover of claim 1 which further includes means for removably detachably securing the cover to the appliance.

6. A cover for an exercise appliance, comprising:
a shoulder supporting portion having: (a) an upper surface, a lower surface, (b) an anti-slip liner secured to the lower surface, and (c) a synthetic rubber material overlying and secured to the upper surface.
